(19) United States
(12) Patent Application Publication
(10) Pub. No.: US 2005/0286386 A1
(43) Pub. Date: Dec. 29, 2005

(54) Dichroic coating for holographic data storage media

(76) Inventors: Jathan D. Edwards, Afton, MN (US); Frank E. Aspen, St. Paul, MN (US)

Correspondence Address: Imation Corp., PO Box 64898, St. Paul, MN, 55164-0898, US

(21) Appl. No.: 10/879,841

(22) Filed: Jun. 29, 2004

(51) Int. Cl. G11B 7/00

(52) U.S. Cl. 369/103; 369/112.01

(57) ABSTRACT

The invention provides a dichroic coating for holographic media. The dichroic coating is substantially non-reflective of light at a first wavelength and substantially reflective of light at a second wavelength. A holographic recording material of the medium can be formulated to be sensitive to the first wavelength of light, but generally insensitive to the second wavelength. A probe beam at the second wavelength can be used to interrogate the medium and identify tracking features.

### TECHNICAL FIELD

The invention relates to holographic data storage media, and more particularly to coatings for holographic data storage media.

### BACKGROUND

Many different types of data storage media have been developed to store information. Traditional media, for instance, include magnetic media, optical media, and mechanical media to name a few. Increasing data storage density is a paramount goal in the development of new or improved types of data storage media.

In traditional media, individual bits are stored as distinct mechanical, optical, or magnetic changes on the surface of the media. For this reason, medium surface area imposes physical limits on data densities for a given recording technique.

Holographic data storage media can offer higher storage densities than traditional media. In a holographic data storage medium, data can be stored throughout the volume of the medium rather than the medium surface. In other words, holographic data storage media permit three-dimensional data storage. Theoretical holographic storage densities can approach tens of terabits per cubic centimeter.

In holographic data storage media, entire pages of information, e.g., bitmaps, can be stored as optical interference patterns within a photosensitive optical material. This is done by intersecting two coherent laser beams within the optical material. The first laser beam, called the object beam, contains the information to be stored; and the second, called the reference beam, interferes with the object beam to create an interference pattern that can be stored in the optical material as a hologram. When the stored hologram is later illuminated with only the reference beam, some of the light of the reference beam is diffracted by the holographic interference pattern. Moreover, the diffracted light creates a reconstruction of the original object beam. Thus, by illuminating a recorded hologram with the reference beam, the data encoded in the object beam can be recreated and detected by a data detector, such as a camera.

A variety of holographic media have been developed. A holographic medium generally includes at least one substrate and a holographic recording material. For example, the holographic recording material may be formed over the substrate, and additional layers may optionally be formed over the holographic recording material. Holograms which represent encoded data are stored within the holographic recording material and read from the holographic recording material.

Another common type of holographic medium is a sandwich construction holographic medium. In that case, the holographic recording material is sandwiched between two substrates. The substrates can provide environmental encapsulation of the holographic recording material, allowing more sensitive photopolymer materials to be used in the formulation of the holographic recording material. Features may be formed on the edges of the substrates to improve the encapsulation of the photosensitive holographic recording material, or a separate ring element or foil can be attached to the perimeter of the medium. Holographic media commonly have a disk-shape, although card shaded media or any other shaped media could also be used.

One challenge for holographic media relates to tracking of stored holograms for readout. In particular, tracking of the various locations of stored holograms in a holographic medium can be difficult, particularly when multiplexing techniques are used to increase the number of stored holograms and thereby improve the storage capacity. One technique used to overcome these tracking challenges is to form tracking patterns on the surface of one or more holographic medium substrates. The tracking patterns may be replicated, molded, stamped, mastered, embossed, etched, ablated, or the like. As examples, the tracking pattern may have stepped changes in the grating period or may have periodic changes in the grating period. Alternatively, the tracking pattern may be defined by a beat frequency of two or more gratings. Such patterns are particularly useful for holographic media because they facilitate the ability to pinpoint tracks of holographic bit maps in the medium which can be spaced relatively large distances apart. A probe beam may be used to facilitate detection of the tracking patterns, with a different laser beam being used to record and read stored holograms in the holographic recording material.

### SUMMARY

In general, the invention provides a dichroic coating for holographic media. The dichroic coating is substantially non-reflective of light at a first wavelength and substantially reflective of light at a second wavelength. In one example, the dichroic coating transmits substantially all light at the first wavelength, e.g., transmits greater than 98 percent of the light at the first wavelength, but reflects a substantial portion of light at the second wavelength, e.g., reflects at least 5 percent of light at the second wavelength. The holographic recording material of the medium can be formulated to be sensitive to the first wavelength of light, but generally insensitive to the second wavelength. A probe beam at the second wavelength can be used to illuminate the medium and identify tracking features via reflection or refraction of a substantial portion of the probe beam.

In one embodiment, the invention provides a holographic data storage medium comprising a substrate including a surface formed with tracking features and a dichroic coating formed over the tracking features of the substrate, wherein the dichroic coating is substantially non-reflective of light at a first wavelength and substantially reflective of light at a second wavelength. The medium may also include a holographic recording material formed over the dichroic coating such that the surface of the substrate formed with the tracking features is covered by the holographic recording material.

In another embodiment, the invention provides a holographic data storage medium comprising a first substrate, a second substrate and a holographic recording material sandwiched between the first and second substrates. The medium may also include a dichroic coating formed on an inner surface of the first substrate such that the dichotic coating is sandwiched between the holographic recording material and the first substrate.

In another embodiment, the invention provides a reflective-mode holographic data storage medium comprising a first substrate including at least one surface formed with tracking features, a second substrate, and a holographic recording material sandwiched between the first and second substrates. The medium may also include a dichroic coating formed over a surface of the first substrate, wherein the dichroic coating is substantially non-reflective of light at a first wavelength and substantially reflective of light at a second wavelength, and wherein the reflective mode-holographic data storage medium reflects a reference beam during readout to reconstruct holograms stored in the holographic recording medium.

The invention may provide one or more advantages. In particular, the dichroic coating which transmits substantially all light at the first wavelength, but reflects a substantial portion of light at the second wavelength can improve the ability to track the location of holograms on a holographic data storage medium. Tracking features can be formed on a substrate of the medium, which can be detected via a probe beam of the second wavelength. The holographic recording material of the medium can be formulated to be sensitive to the first wavelength so that the first wavelength, which is substantially entirely transmitted through the dichroic coating, can be used efficiently. These advantages can ultimately equate to higher storage capacity for holographic media, which is generally a paramount goal for all data storage media.

In accordance with the invention, the holographic recording material of a holographic recording medium can be formed over the dichroic coating such that the surface of the substrate formed with the tracking features is covered by the holographic recording material. Moreover, for reflective mode holographic media, the dichroic coating can function as a layer that substantially reflects a reference beam during readout, yet substantially transmits the probe beam to facilitate tracking of the transmitted probe beam.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is conceptual cross-sectional view illustrating a holographic data storage medium according to an embodiment of the invention.

FIG. 2 is a perspective view of a sandwich construction holographic medium according to an embodiment of the invention.

FIGS. 3-6 are conceptual cross-sectional views illustrating a holographic data storage media according to various embodiments of the invention.

FIG. 7 is a block diagram illustrating a system according to an embodiment of the invention.

FIGS. 8-10 are graphs illustrating experimental results.

### DETAILED DESCRIPTION

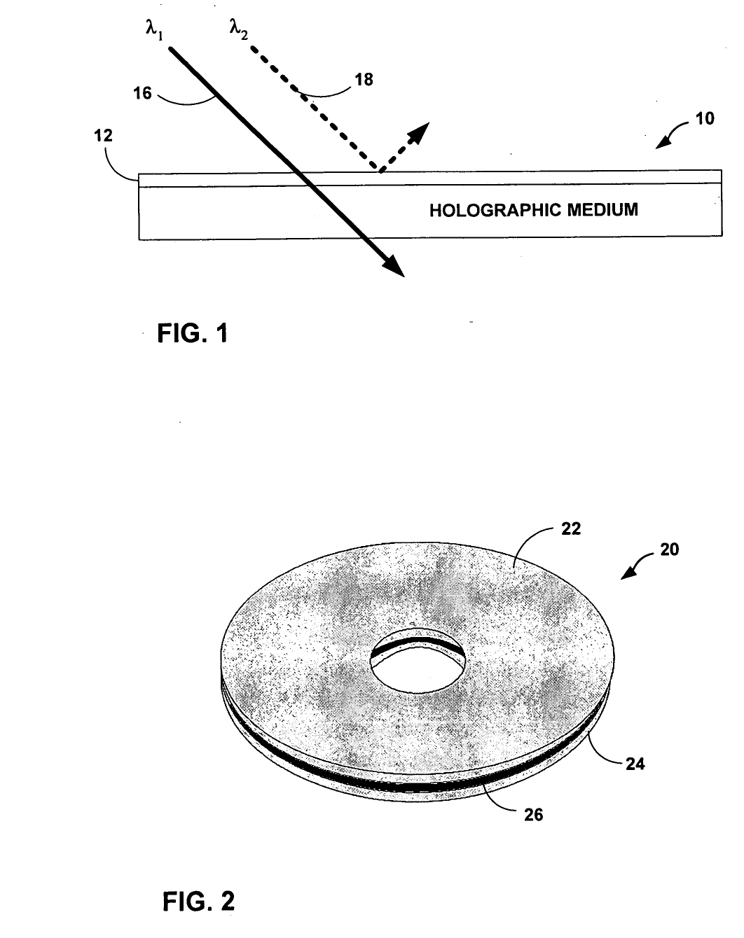

FIG. 1 is conceptual cross-sectional view illustrating a holographic data storage medium 10 according to an embodiment of the invention. As shown, holographic data storage medium 10 includes a dichroic coating 12. As described in greater detail below, dichroic coating 12 can improve medium 10 by substantially reflecting light of one wavelength and substantially transmitting light of another wavelength.

The first wavelength of light (λ₁) may correspond to the light used to read and record holograms in medium 10. Thus, dichroic coating 12 is non-reflective, i.e., transmissive with respect to the first wavelength of light. For example, dichroic coating 12 may transmit greater than 98 percent, greater than 99 percent, or even greater than 99.9 percent of light at the first wavelength. In other words, dichroic coating 12 may reflect less than 2 percent, less than 1 percent, or even less than 0.1 percent of light at the first wavelength. By way of example, the first wavelength of light may be blue light having a wavelength of approximately 405 nanometers, or green light having a wavelength of approximately 532. The invention, however, is not limited in that respect. Optical beam 16 illustrates light at the first wavelength, which is substantially entirely transmitted through dichroic coating 12.

In order to improve tracking capabilities, holographic data storage medium 10 may include various tracking features which can be optically detected. For example, the tracking features may be formed on medium 10, e.g., in a substrate of medium 10. Light which reflects off of medium 10 can be detected to facilitate such tracking. For example, a probe beam 18 of a second wavelength (λ₂) can be used to detect the tracking features on medium 10.

Dichroic coating 12 reflects a substantial portion of probe beam 18, e.g., at least greater than 5 percent and typically greater than 10 or 15 percent. In other words, dichroic coating 12 transmits less than 95 percent and typically less than 90 or 85 percent of the probe beam. In this sense, dichroic coating 12 reflects a substantial portion of light at the second wavelength so that the probe beam can be reflected and used for tracking. Again, dichroic coating 12 may reflect greater than 5 percent, greater than 10 percent, greater than 15 percent, or more, of light at the second wavelength. In this manner, dichroic coating 12 allows substantially all light of the first wavelength to pass for use in recording and reading holograms, but reflects a substantial portion of light of the second wavelength so that tracking features on medium 10 can be detected. A photosensitive holographic recording material in medium 10 is sensitive to the first wavelength of light, but may be less sensitive or insensitive to the second wavelength of light. By way of example, the second wavelength of light may be between 600 and 700 nanometers, although the invention is not limited in that respect. Red light of wavelengths of 630 nanometers, 650 nanometers, or 680 nanometers, for example, may function well as probe beam 16 that is substantially reflected by dichroic coating 12.

In accordance with the invention, holographic data storage medium 10 may assume a variety of shapes sizes and forms. For example, holographic data storage medium 10 may assume a disk-shape, a card-shape, or any other shape that is desirable. In addition, holographic data storage medium 10 may be a reflective or transmissive medium. More details of reflective-mode and transmissive-mode holographic media are provided below.

Holographic data storage medium 10 may comprise any of a wide variety of holographic media that have been developed. A holographic medium generally includes at least one substrate and a holographic recording material. For example, the holographic recording material may be formed over the substrate, and additional layers may optionally be formed over the holographic recording material. Holograms which represent encoded data are stored to the holographic recording material and read from the holographic recording material.

Holographic data storage medium 10 may also comprise a sandwich construction holographic medium. In that case, the holographic recording material is sandwiched between two substrates. The substrates can provide environmental encapsulation of the holographic recording material, allowing more sensitive photopolymer materials to be used in the formulation of the holographic recording material. Features can be formed on the edges of the substrates to improve the encapsulation, or a separate ring element or foils can be attached to the perimeter of the medium. Holographic media commonly have a disk-shape, although card-shaded media or any other shaped media could also be used.

Again, holographic data storage medium 10 may be transmissive or reflective. In transmissive holographic media, holograms are recorded in the medium and then subsequent illumination through the medium can reconstruct the holograms on the side opposite the illumination source. In reflective holographic media, holograms are recorded in the medium and then subsequent illumination onto the medium is reflected to reconstruct the holograms. The design and functionality of dichroic coating 12 may depend on whether medium 10 is transmissive or reflective. For example, dichroic coating 12 for a transmissive medium may transmit light at one wavelength and reflect another. For reflective media, dichroic coating 12 may function exactly opposite, reflecting the one wavelength and transmitting the other. In any case, dichroic coating 12 can improve medium 10 by improving the ability to use a separate probe beam 18 to track locations on medium 10 with good precision.

Tracking is very challenging for holographic media. The tracking of the various locations of stored holograms in a holographic medium can be difficult, particularly when multiplexing techniques are used to increase the number of stored holograms and thereby improve the storage capacity. One technique used to overcome these tracking challenges is to form tracking patterns on the surface of one or more holographic medium substrates. The tracking patterns may be molded, replicated, stamped, mastered, embossed, etched, ablated, on one or both of the substrates. Dichroic coating 12 can be applied over a surface of the substrate to substantially transmit light used to record and read holograms, and reflect a substantial portion of light used to reflect off the tracking pattern.

The tracking pattern on medium 10 may have stepped changes in the grating period or may have periodic changes in the grating period. Alternatively, the tracking pattern may be defined by a beat frequency of at least two grating periods. Such patterns are particularly useful for holographic media because they facilitate the ability to pinpoint tracks of holographic bit maps in the medium which can be spaced relatively large distances apart. Again, probe beam 18 may be used to facilitate tracking, with a different laser beam 16 being used to record and read stored holograms. Beams 16 and 18 have different wavelengths relative to one another.

FIG. 2 is a perspective view of a sandwich construction holographic medium 20 according to an embodiment of the invention, which may also correspond to medium 10 (FIG. 1). Sandwich construction holographic medium 20 comprises a first substrate 22, a second substrate 24 and a holographic recording material 26 sandwiched between substrates 22, 24. At least one surface of one of substrates 22, 24 includes a dichroic coating as described herein and illustrated in FIG. 1. Tracking features can be formed on one or more of the surfaces of substrates 22, 24. In accordance with the invention, the tracking features and dichoric coating may both exist on an inner surface of one of substrates 22, 24, i.e., at the interface between the substrate and holographic recording material 26.

Although illustrated as being disk shaped, holographic data storage medium 20 could alternatively assume other geometries, such as a card-shape or any other shape. Substrates 22 and 24 may be formed of a thermoplastic material such as polycarbonate, amorphous polyolefin or Poly methyl methacrylate (PMMA). Desirable substrate thickness may fall between 0.5 and 2.0 millimeters in order to achieve a desirable balance between birefringence, stiffness, and the edge wedge phenomenon. Such substrate materials and thicknesses have shown to be very useful and can be easily molded to include tracking features. If desired, features can be formed on the edges of substrates 22, 24 to improve the encapsulation of holographic recording material 26. Also, a separate ring element or foils can be attached to the perimeter of substrates 22, 24 to encapsulate holographic recording material 26.

By way of example, holographic recording material 26 may comprise a multi-chemistry holographic formulation formed of two or more components. For example, a two-chemistry formulation could be used, but the same principles could be extended for use with three-chemistry formulations, four-chemistry formulations, and so forth.

Holograms of bit maps can be recorded and stored in holographic recording material 26 to facilitate data storage. For example, a two-chemistry urethane formulation may be formed of a first isocyanate component including a photoinitiator and a second polyol component including an acrylate write monomer. Additives or other components may also be included in holographic recording material 26, such as a catalyst to increase the rate at which the formulation cures or sets. The additive may be included in either or both components of a two-chemistry formulation or may be introduced as a separate component, e.g., of a three-chemistry formulation. In that case, holographic recording material 26 is typically created by mixing the various components prior to injection between substrates 22, 24.

In order to minimize pre-exposure or other negative effects on holographic recording material 26, the probe beam (FIG. 1, 18) is chosen to have a wavelength such that doesn't degrade the dynamic range of holographic recording material 26. Dichroic coating 12 is designed to minimize surface reflections and thereby avoid such reflections from affecting the holographic recording material 26 during the recording step and to minimize stray light to contribute to data detector noise during reconstruction of the holographic data pages (readout). The anti-reflection performance of dichroic coating 12 should be designed with wavelength, angle of incidence, and polarization in mind. In order to accomplish these objectives, dichroic coating 12 may comprise a multi-layer thin film stack that is designed to minimize reflections for one (recording/readout) optical beam 16 while maximizing reflections for another (tracking/positioning) probe beam 18.

Dichroic coating can be specifically designed as outlined in the various examples below. However, relatively good optical functionality of reflection of one optical wavelength and transmission of another can also be accomplished using a dichroic filter coating commercially available from commercial suppliers. Conventionally, these dichroic filter coatings are used to separate or combine optical paths of differing wavelength. For the holographic data storage media application, however, the invention utilizes the dichroic functionality to minimize reflection for a recording/readout beam, e.g., s-polarized blue light at 405 nanometers at angle of incidence between 20 to 60 degrees. At the same time, the dichroic coating maximizes reflection of a probe beam used for tracking and positioning. As an example, the probe beam may operate in red light of approximately 650 nanometers with normal incidence (90 degrees). Using a probe beam in concert with the properly designed dichroic coating enables sufficient optical reflection for tracking feedback, and can also allow for pointing or focusing corrections of the optical beams during holographic recording and/or readout.

As a general extension, coatings selected to simultaneously minimize surface reflections for one wavelength (e.g., the recording/readout beam) while maximizing reflection of a second wavelength (e.g., the probe beam used for tracking), may be applied to one or two substrates. Furthermore, some optical systems may warrant less reflection of the probe beam, i.e., a partial reflector applied to the surface of the holographic media. For example, dichroic coating 12 may be designed such that a first outer surface reflects one portion of the incident light and a second portion of the coating reflects a second portion of the light.

As a further generalization, the invention may also be advantageous for either transmission based holographic media or for a reflective mode holograhic media. In a reflection-type holographic medium, the optical beams used for record/readout reflect through the holographic recording layer and may allow for a single-sided optical system to interrogate the media. As yet another variation, a reflective-type holographic medium can be fabricated by replacing a conventional mirror/reflector element of the medium by a multilayer dichroic film stack to reflect the record/readout laser light while transmitting a probe beam laser light.

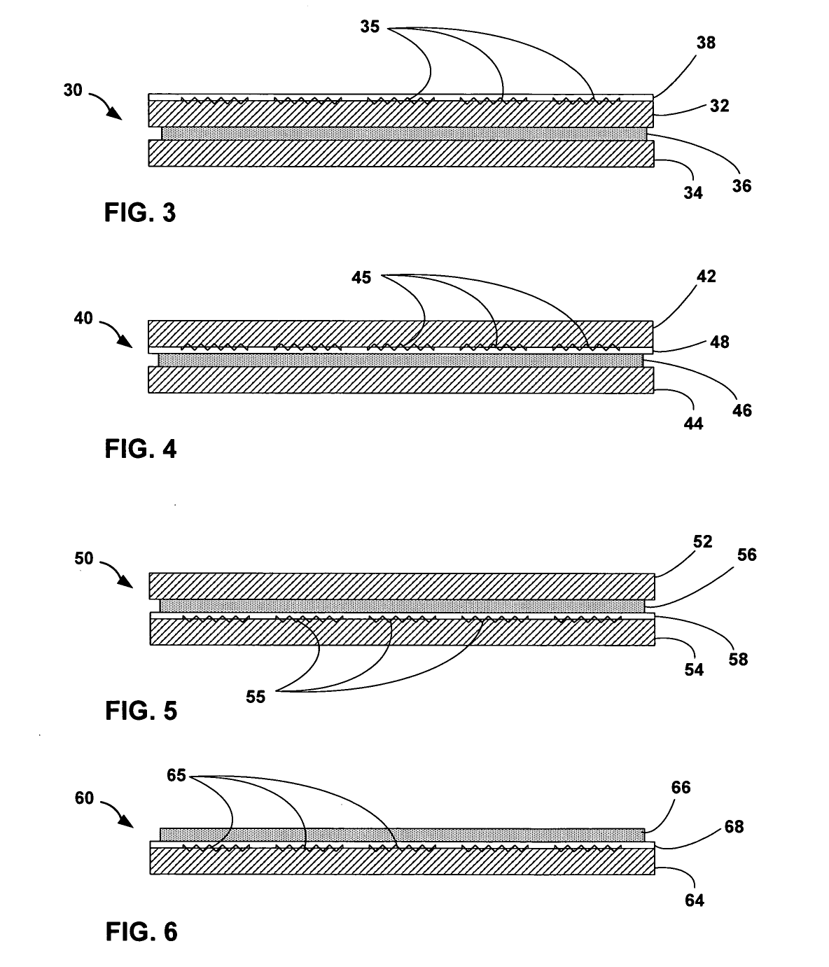

FIG. 3 is a conceptual cross-sectional view illustrating a holographic data storage medium 30 according to an embodiment of the invention. Holographic data storage medium 30 comprises a first substrate 32, a second substrate 34 and a holographic recording material 36 sandwiched between substrates 32, 34. Substrates 32 and 34 may be formed of materials, shapes or sizes described above with reference to FIG. 2. Holographic recording material 36 may also comprise a formulation as described above with reference to FIG. 2.

Substrate 32 includes tracking pattern 35 formed on the outer surface of substrate 32. The tracking pattern 35 can be replicated, molded, stamped, mastered, embossed, etched, ablated, or the like. As examples, tracking pattern 35 may have stepped changes in the grating period or may have periodic changes in the grating period. Alternatively, the tracking pattern may be defined by a beat frequency of two or more gratings. These examples are not limiting of the invention, however, as other types of tracking patterns could also be used.

In accordance with the invention, holographic data storage medium 30 includes a dichroic coating 38. In this example, dichroic coating 38 is formed on the outer surface of substrate 32, e.g., over tracking pattern 35. A record/readout beam (not shown) of a first frequency is substantially transmitted through dichroic coating 38 so that holograms can be written to read from holographic recording material 36. A probe beam (not shown) of a second frequency is substantially reflected by dichroic coating 38 so that the presence of tracking pattern 35 can be detected and interpreted to facilitate tracking of holograms stored in medium 30.

FIG. 4 is another conceptual cross-sectional view illustrating a holographic data storage medium 40 according to an embodiment of the invention. Holographic data storage medium 40 comprises a first substrate 42, a second substrate 44 and a holographic recording material 46 sandwiched between substrates 42, 44. Again, substrates 42 and 44 may be formed of materials, shapes or sizes described above with reference to FIG. 2. Holographic recording material 46 may also comprise a formulation as described above with reference to FIG. 2.

Substrate 42 includes tracking pattern 45 formed on the inner surface of substrate 42, which can protect the tracking pattern by encapsulation. The tracking pattern 45 can be replicated, molded, stamped, mastered, embossed, etched, ablated, or the like. Again, tracking pattern 45 may have stepped changes in the grating period or may have periodic changes in the grating period. Alternatively, the tracking pattern may be defined by a beat frequency of two or more gratings. These examples, however, are not limiting of the invention, as other types of tracking patterns could also be used.

In accordance with the invention, holographic data storage medium 40 includes a dichroic coating 48. In this example, dichroic coating 48 is formed on the inner surface of substrate 42, e.g., between the interface of substrate 42 and holographic recording material 46. A record/readout beam (not shown) of a first frequency is substantially transmitted through dichroic coating 48 so that holograms can be written to read from holographic recording material 46. A probe beam (not shown) of a second frequency is substantially reflected by dichroic coating 48 so that the presence of tracking pattern 45 can be detected and interpreted to facilitate tracking of holograms stored in medium 40.

FIG. 5 is another conceptual cross-sectional view illustrating a holographic data storage medium 50 according to an embodiment of the invention. Holographic data storage medium 50 comprises a first substrate 52, a second substrate 54 and a holographic recording material 56 sandwiched between substrates 52, 54. Again, substrates 52 and 54 may be formed of materials, shapes or sizes described above with reference to FIG. 2. Holographic recording material 56 may also comprise a formulation as described above with reference to FIG. 2.

Substrate 54 includes tracking pattern 55 formed on the inner surface of substrate 54. The tracking pattern 55 can be replicated, molded, stamped, mastered, embossed, etched, ablated, or the like. Again, tracking pattern 55 may have stepped changes in the grating period or may have periodic changes in the grating period. Alternatively, the tracking pattern may be defined by a beat frequency of two or more gratings. These examples, however, are not limiting of the invention, as other types of tracking patterns could also be used.

In accordance with the invention, holographic data storage medium 50 includes a dichroic coating 58. In this example, dichroic coating 58 is formed on the inner surface of substrate 54, e.g., between the interface of substrate 54 and holographic recording material 56. In this example, however, a record/readout beam (not shown) of a first frequency is substantially reflected by dichroic coating 58 so that holograms can be written to read from holographic recording material 56 in a reflective mode of operation. A probe beam (not shown) of a second frequency is substantially transmitted by dichroic coating 58 so that the presence of tracking pattern 55 can be detected and interpreted to facilitate tracking of holograms stored in medium 50.

FIG. 6 is another conceptual cross-sectional view illustrating a holographic data storage medium 60 according to an embodiment of the invention. Holographic data storage medium 60 comprises a substrate 64 and a holographic recording material 66 formed on substrate 64. A sealing layer may also be formed over holographic recording material 66.

Substrate 64 includes tracking pattern 65 formed on the inner surface of substrate 64. The tracking pattern 65 can be replicated, molded, stamped, mastered, embossed, etched, ablated, or the like. Again, tracking pattern 65 may have stepped changes in the grating period or may have periodic changes in the grating period. Alternatively, the tracking pattern may be defined by a beat frequency of two or more gratings, or any other type of tracking pattern.

Holographic data storage medium 60 includes a dichroic coating 68. In this example, dichroic coating 68 is formed on the inner surface of substrate 64, e.g., between the interface of substrate 64 and holographic recording material 66. In this example, a record/readout beam (not shown) of a first frequency is substantially reflected by dichroic coating 68 so that holograms can be written to read from holographic recording material 66 in a reflective mode of operation. A probe beam (not shown) of a second frequency is substantially transmitted by dichroic coating 68 so that the presence of tracking pattern 65 can be detected and interpreted to facilitate tracking of holograms stored in medium 60.

The various media illustrated in FIGS. 3-6 are only exemplary. In accordance with other embodiments of the invention, a dichroic coating may be applied on other surfaces of the medium, or other substrate surfaces. Also, tracking features and the dichroic coating are not necessarily required to be formed on a common surface and may be formed on different surfaces or different substrates. The dichroic coating can be designed to substantially entirely transmit a first frequency, and substantially reflect a second frequency. Which frequencies are transmitted and reflected, however, may depend on the frequencies chosen for the record/read beam and the probe beam, as well as the design of the medium, e.g., based on whether the medium is a reflective type or transmissive type holographic medium.

The dichroic coating may comprise a multi-layered stack. For example, the dichroic coating may comprise alternating sub-layers of Tantalum Oxide (Ta₂O₅) and Silicon Oxide (SiO₂). Four layer stacks using two sub-layers of Tantalum Oxide and two sub-layers of Silicon Oxide may be used. Also, five layer stacks having three sub-layers of Tantalum Oxide and two sub-layers of Silicon Oxide may be used. Also, seven-layer stacks having four sub-layers of Tantalum Oxide and three sub-layers of Silicon Oxide may be used. In accordance with the invention, any number of sub-layers may be used to create the multi-layered dichroic stack. Moreover, the thicknesses of the various sub-layers can be selected based on the desired wavelengths to be transmitted and reflected.

The following examples provide additional details of specific dichroic coatings comprising multi-layered stacks. The examples are not meant to be limiting of the invention in any way.

### EXAMPLE 1

In this example, a medium similar to medium 40 (FIG. 4) or medium 50 (FIG. 5) was prepared. The dichroic coating consisted of five layers as listed in TABLE 1 below. Layer 1 was formed adjacent the substrate surface.

TABLE 1

| Layer # | Index (n) | Thickness (nm) |
|---|---|---|
| 1 | 2.30 | 8.3 |
| 2 | 1.48 | 32.4 |
| 3 | 2.30 | 101.5 |
| 4 | 1.48 | 32.4 |
| 5 | 2.30 | 8.3 |

The material used having an n=2.3 at 405 nm was Ta2O5. The material used having n=1.48 at 405 nm was SiO2.

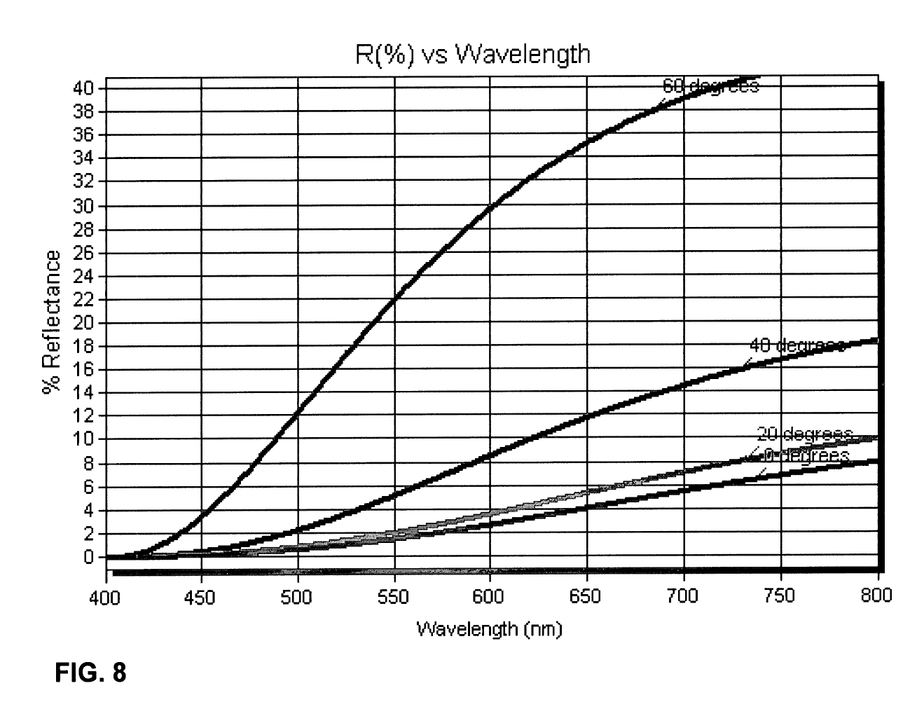

The reflectivity of the interfacial dichroic coating formed on the medium is graphed in FIG. 8. In particular, the reflectivity is graphed for incident angles of 0 degrees, 20 degrees, 40 degrees and 60 degrees. The formed coating would serve as layer 48 in medium 40 or layer 58 in medium 50. As can be seen from FIG. 8, the reflectivity at 405 nm is approximately 0% for all angles from 0 to 60 degrees while the reflectivity at 650 nm ranges from 4% to 35% over that range of angles.

### EXAMPLE 2

In this example, another medium similar to medium 40 (FIG. 4) or medium 50 (FIG. 5) was prepared. However, in this example, the dichroic coating consisted of seven layers as listed in TABLE 2 below. Layer 1 was formed adjacent the substrate surface.

TABLE 2

| Layer # | Index (n) | Thickness (nm) |
|---|---|---|
| 1 | 2.30 | 7.7 |
| 2 | 1.48 | 38.2 |
| 3 | 2.30 | 112.9 |
| 4 | 1.48 | 30.3 |
| 5 | 2.30 | 112.9 |
| 6 | 1.48 | 38.2 |
| 7 | 2.30 | 7.7 |

Like Example 1, the material used in Example 2 having an n=2.3 at 405 nm was Ta2O5. The material used having n=1.48 at 405 nm was SiO2.

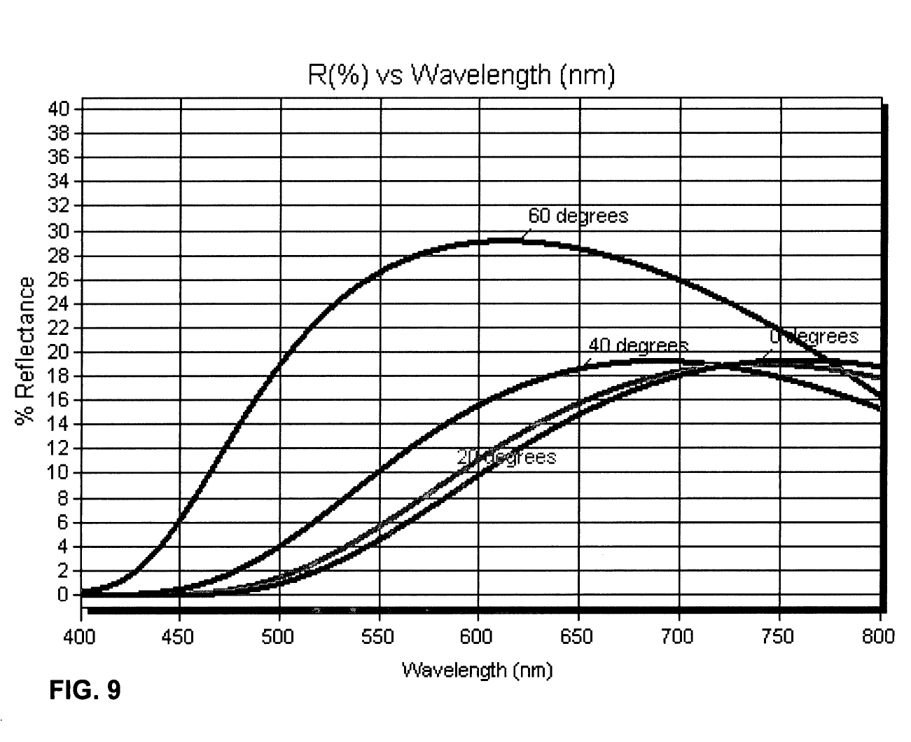

The reflectivity of the interfacial dichroic coating formed on the medium is graphed in FIG. 9. In particular, the reflectivity is graphed for incident angles of 0 degrees, 20 degrees, 40 degrees and 60 degrees. The formed coating would serve as layer 48 in medium 40 or layer 58 in medium 50. As can be seen from FIG. 9 relative to FIG. 8, the 7-layer film stack accomplished greater discrimination between wavelengths relative to the 5-layer stack.

### EXAMPLE 3

In this example, a medium similar to medium 30 (FIG. 3) was prepared. The dichroic coating consisted of five layers as listed in TABLE 3 below. Layer 1 was formed adjacent the substrate surface.

TABLE 3

| Layer # | Index (n) | Thickness (nm) |
|---|---|---|
| 1 | 1.48 | 127.6 |
| 2 | 2.30 | 78.2 |
| 3 | 1.48 | 105.9 |
| 4 | 2.30 | 61.5 |
| 5 | 1.48 | 58.9 |

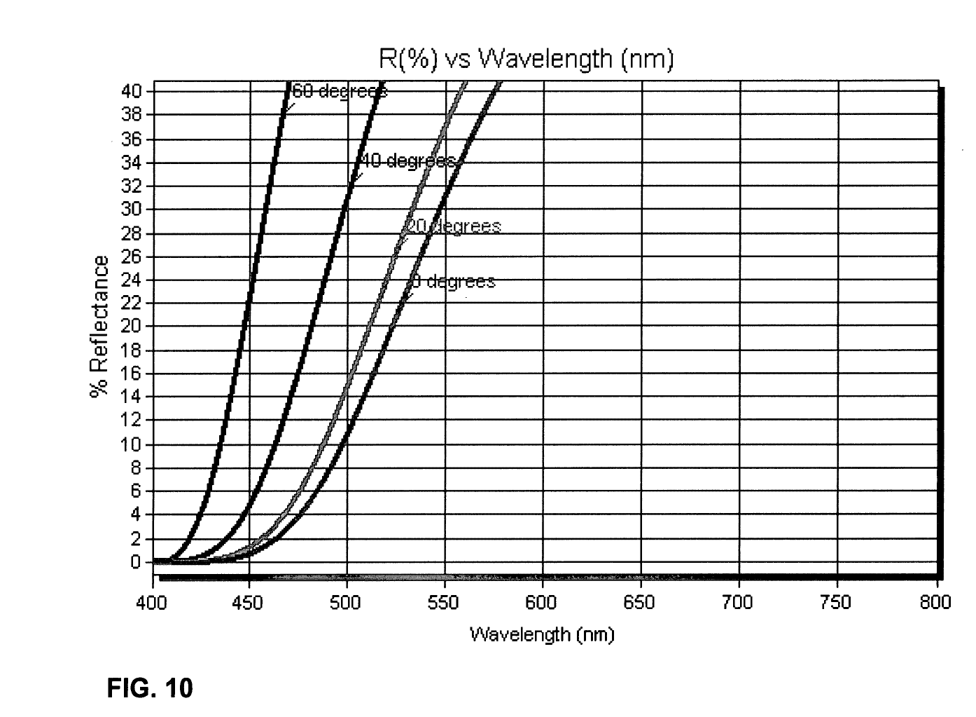

Like Examples 1 and 2, the material used having an n=2.3 at 405 nm was Ta2O5. The material used having n=1.48 at 405 m was SiO2. The reflectivity of the interfacial dichroic coating formed on the medium is graphed in FIG. 10. In particular, the reflectivity is graphed for incident angles of 0 degrees, 20 degrees, 40 degrees, and 60 degrees. The formed coating would serve as layer 38 in medium 30.

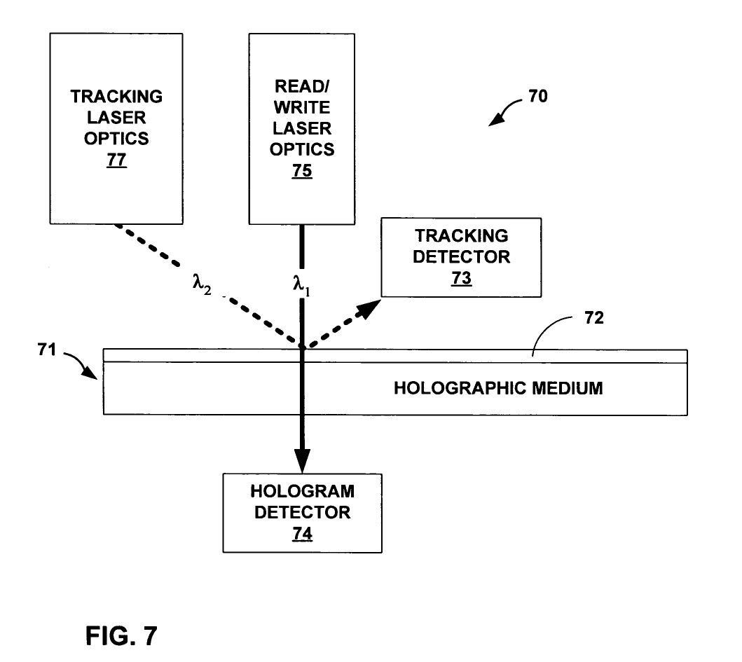

FIG. 7 is a block diagram illustrating a holographic data storage system 70. System 70 includes holographic data storage medium 71, which may correspond to any of the media described herein. In particular, holographic data storage medium 71 includes a dichroic coating 72. System 70 also includes various components for writing data to medium 71 or reading data from medium 71. In particular, system 70 includes read/write laser optics 75 which generate optical beam 76. Optical beam 76 generally represents object and reference beams used to create holograms in medium 71, or simply a reference beam used to reconstruct stored holograms. Read/write laser optics 75 may include a laser, various lenses, mirrors, beams slitters, or other optical components used to create or reconstruct holograms. System 70 includes tracking laser optics 77 which generate probe beam 78. Tracking laser optics 77 may include a laser and various optical components to condition probe beam 78 for use in tracking.

Holographic medium 71 includes a dichroic coating 72 as described herein. Dichroic coating 72 is non-reflective, i.e., transmissive with respect to optical beam 76 at the first wavelength of light. Again, dichroic coating 72 may transmit greater than 98 percent, greater than 99 percent, or even greater than 99.9 percent of light at the first wavelength. However, dichroic coating 12 reflects a substantial portion of probe beam 78 at the second wavelength. For example, dichroic coating 72 may reflect at least greater than 5 percent and typically greater than 10 or 15 percent of light at the second wavelength. For sandwiched construction media, the dichroic coating may be applied over tracking features on an inner substrate surface of the medium.

Holographic system 70 further includes a tracking detector 73 and a hologram detector 74. For example, tracking detector 73 may comprise an array of photodetectors and hologram detector 74 may comprise a camera. Other types of detectors could also be used. In any case, tracking detector 73 detects the reflected portion of probe beam 78 in order to facilitate tracking. For example, tracking detector can detect the reflected portion of probe beam 78 to identify tracking features formed on medium 71. Tracking detector 73 may provide feedback signals to read/write laser optics 75 and tracking laser optics 77 in order to facilitate precise positioning of optics 75, 77 relative to medium 71. The precise positioning allows hologram detector 74 to detect the appropriate holograms for data readout. The various optics 75, 77 and detectors 73, 74 of FIG. 7 may be mechanically coupled to one another such that optics 75, 77 and detectors 73, 74 can move collectively relative to medium 71.

The illustration of FIG. 7 makes use of transmissive mode media. In other examples, the invention may comprise a reflective mode medium. In that case, the reference beam is reflected by the medium during readout and holograms are reconstructed and imaged on the illuminated side of the medium. The probe beam, however, may transmit through the medium in this reflective mode example. In this case, the dichroic coating can function as a layer that substantially reflects a reference beam during readout, yet substantially transmits the probe beam to facilitate tracking of the transmitted probe beam.

Various embodiments of the invention have been described. In particular, various dichroic coatings for use with various holographic media have been described. The coatings may be applied over tracking features formed on an inner substrate surface of a sandwiched construction medium, or in other ways described herein. These and other embodiments are within the scope of the following claims.

1. A holographic data storage medium comprising:
a substrate including a surface formed with tracking features;
a dichroic coating formed over the tracking features of the substrate, wherein the dichroic coating is substantially non-reflective of light at a first wavelength and substantially reflective of light at a second wavelength; and
a holographic recording material formed over the dichroic coating such that the surface of the substrate formed with the tracking features is covered by the holographic recording material.

2. The holographic data storage medium of claim 1, further comprising:
a first substrate; and
a second substrate, wherein the holographic recording material is sandwiched between the first and second substrates and wherein the dichroic coating is formed over an inner surface of one of the substrates.

3. The holographic data storage medium of claim 1, wherein the first wavelength is between approximately 600 and 700 nanometers and the second wavelength is one of approximately 405 nanometers and 532 nanometers.

4. The holographic data storage medium of claim 1, wherein the first wavelength is one of approximately 405 nanometers and 532 nanometers and the second wavelength is between approximately 600 and 700 nanometers.

5. The holographic data storage medium of claim 1, wherein the dichroic coating comprises a multi-layered stack.

6. The holographic data storage medium of claim 1, wherein the dichroic coating transmits greater than 98 percent of light at the first wavelength and reflects greater than 5 percent of light at the second wavelength.

7. The holographic data storage medium of claim 1, wherein the dichroic coating transmits greater than 99 percent of light at the first wavelength and reflects greater than 15 percent of light at the second wavelength.

8. The holographic data storage medium of claim 1, wherein the medium is a reflective holographic medium that reflects holograms during readout.

9. The holographic data storage medium of claim 1, wherein the medium is a transmissive holographic medium that transmits holograms during readout.

10. A holographic data storage medium comprising:
a first substrate;
a second substrate;
a holographic recording material sandwiched between the first and second substrates; and
a dichroic coating formed on an inner surface of the first substrate such that the dichotic coating is sandwiched between the holographic recording material and the first substrate.

11. The holographic data storage medium of claim 10, the first substrate includes tracking features, and wherein the dichroic coating is formed over the tracking features.

12. The holographic data storage medium of claim 10, wherein the first wavelength is between approximately 600 and 700 nanometers and the second wavelength is one of approximately 405 nanometers and 532 nanometers, and wherein the dichroic coating transmits greater than 99 percent of light at the first wavelength and reflects greater than 10 percent of light at the second wavelength.

13. The holographic data storage medium of claim 10, wherein the first wavelength is one of approximately 405 nanometers and 532 nanometers and the second wavelength is between approximately 600 and 700 nanometers, and wherein the dichroic coating transmits greater than 99 percent of light at the first wavelength and reflects greater than 10 percent of light at the second wavelength.

14. The holographic data storage medium of claim 10, wherein the holographic recording material is substantially sensitive to light at a first wavelength and wherein the dichroic coating comprises a multi-layered stack.

15. A reflective-mode holographic data storage medium comprising:
a first substrate including at least one surface formed with tracking features;
a second substrate;
a holographic recording material sandwiched between the first and second substrates; and
a dichroic coating formed over a surface of the first substrate, wherein the dichroic coating is substantially non-reflective of light at a first wavelength and substantially reflective of light at a second wavelength, and wherein the reflective mode-holographic data storage medium reflects a reference beam during readout to reconstruct holograms stored in the holographic recording medium.

16. The reflective-mode holographic data storage medium of claim 15, wherein the dichroic coating is formed over the tracking features of the first substrate.

17. The reflective-mode holographic data storage medium of claim 15, wherein the dichroic coating is formed on an inner surface of the first substrate such that the tracking features are covered by the holographic recording material.

18. The reflective-mode holographic data storage medium of claim 15, wherein the reference beam defines a wavelength that substantially corresponds to the second wavelength and wherein the dichroic coating substantially reflects the reference beam during readout.
